(19) United States
(12) Patent Application Publication
(10) Pub. No.: US 2004/0262503 A1
(43) Pub. Date: Dec. 30, 2004

(54) Position encoder

(75) Inventors: David D. Martenson, Oregon City, OR (US); David L. Knierim, Wilsonville, OR (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 10/608,880

(22) Filed: Jun. 26, 2003

(51) Int. Cl. G01D 5/34; H01J 3/14

(52) U.S. Cl. 250/231.13; 250/237 R; 250/231.14

(57) ABSTRACT

An optical encoder that includes an optical grating and a quadrature optical encoder sensor that move relative to each other. The optical grating includes alternating dark and light areas, wherein one or more of the light areas are optically different from other light areas.

### BACKGROUND OF THE DISCLOSURE

Printing systems such as ink jet printers and electrophotographic printers can employ position encoders to track the position of moving components such as print drums and printheads. Position encoders commonly include an optical grating and an optical encoder sensor that move relative to each other pursuant to movement of the component whose position is being tracked. It can be useful to determine a reference or home position for the component whose position is being tracked, and it can be difficult to determine such reference or home position.

### BRIEF DESCRIPTION OF DRAWINGS

FIG. 1 is a schematic block diagram of an embodiment of a printing apparatus.

FIG. 2 is a schematic block diagram of an embodiment of a marking apparatus that can be used in the printing apparatus of FIG. 1.

FIG. 3 is a schematic illustration of an embodiment of a linear optical grating.

FIG. 4 is a schematic illustration of an embodiment of another linear optical grating.

FIG. 5 sets forth schematic quadrature waveforms that would be produced as the linear optical track of FIG. 3 or FIG. 4 moves between the emitter and the detectors of the quadrature optical encoder sensor of FIG. 2.

FIG. 6 is a schematic illustration of an embodiment of a circular optical grating.

FIG. 7 is a schematic illustration of an embodiment of another circular optical grating.

### DETAILED DESCRIPTION OF THE DISCLOSURE

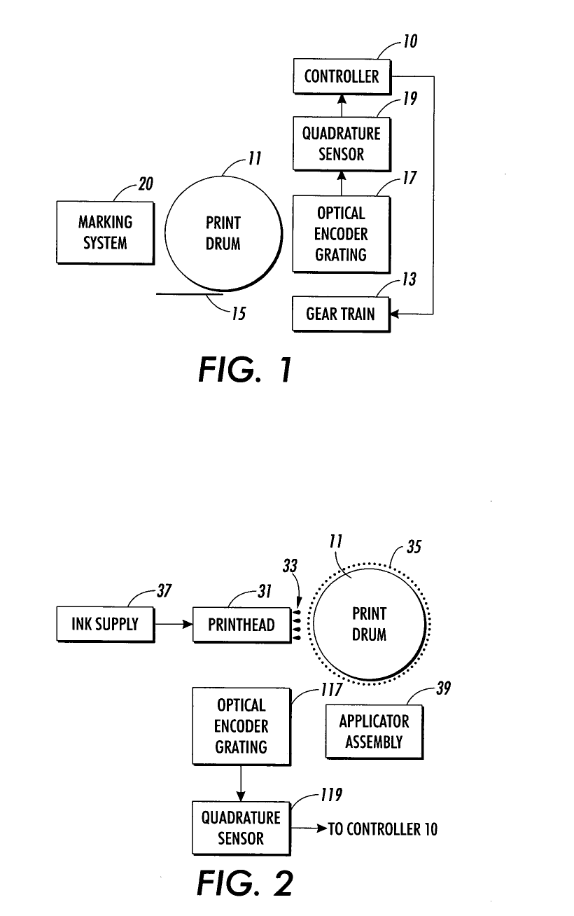

FIG. 1 is a schematic block diagram of an embodiment of a printing apparatus that includes a print drum 11 that is driven by a gear train 13, for example. A marking system 20 applies marking material to the print drum 11 to form an image that is transferred to a print output medium 15. The marking system 20 can be an ink jet marking system or an electrophotographic marking system, for example.

An optical encoder system comprised of an optical encoder grating 17 and a quadrature optical encoder sensor 19 that move relative to each other pursuant to movement of the print drum 11 provide position related information that can be processed by a printer controller 10, for example, to determine angular position of the print drum 11. By way of illustrative example, the optical encoder sensor 19 can be mechanically coupled to the print drum 11 or the gear train 13, or the optical encoder grating 17 can be mechanically coupled to the print drum 11 or the gear train 13. The optical encoder grating 17 includes an optical track that is encoded to identify a predetermined position of the print drum 11. The optical track can generally comprise a series of alternating light and dark areas or regions. In a transmissive system, the light areas would be transmissive while the dark areas would be less transmissive than the light areas. In a reflective system, the light areas would be reflective while the dark areas would be less reflective than the light areas.

For convenience, since the optical tracks disclosed herein can include areas of relative lightness or darkness, when an area is described as being lighter than another area, the lighter area is configured to be more transmissive in a transmissive system or more reflective in a reflective system. Similarly, when an area is described as being darker than another area, the darker area is configured to be less transmissive in a transmissive system or less reflective in a reflective system. Light areas can also be called spaces, slots or windows since they separate dark areas. Dark areas can be conveniently called encoder bars.

By way of illustrative example, the quadrature optical encoder sensor 19 can include a light source or emitter such as an LED and a plurality of photodetectors such as photodiodes for detecting the pattern of light transmitted or reflected by the optical track of the optical encoder grating as it moves through a sense region. The optical track of the optical grating 17 modulates the light provided by the light source, and the quadrature optical encoder sensor 19 senses the light and dark areas of the optical track by detecting the modulated light provided by the optical track. The output of the quadrature optical encoder sensor 19 can comprise quadrature waveforms that can be provided to the controller 10 to control the operation of the gear train 13.

FIG. 2 is a schematic block diagram of an embodiment of a marking system that includes an ink jet printhead 31 that deposits drops 33 of ink on an intermediate transfer surface 35 that is disposed on the print drum 11. The ink drops 33 can be melted solid ink that is provided by a supply 37 of solid ink. The intermediate transfer surface 35 comprises for example a liquid layer that is applied to the print drum 11 by an applicator assembly 39 that can include an oil impregnated roller and a metering wiper or blade, for example as shown in commonly assigned U.S. Pat. No. 6,431,703. A linear optical encoder grating 117 and a quadrature optical encoder sensor 119 can be provided to detect the position of the printhead 31. The linear optical encoder grating 117 can move with movement of the printhead 31, or the quadrature optical encoder sensor can move with movement of the printhead 31.

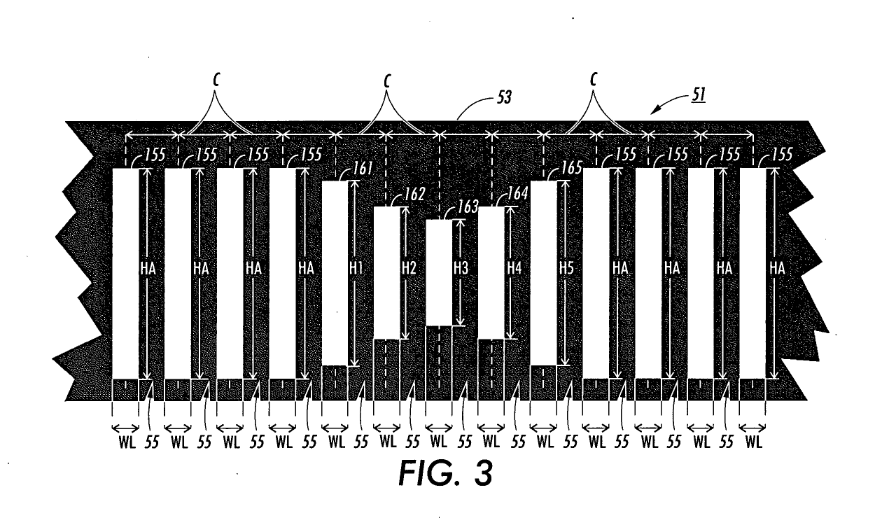

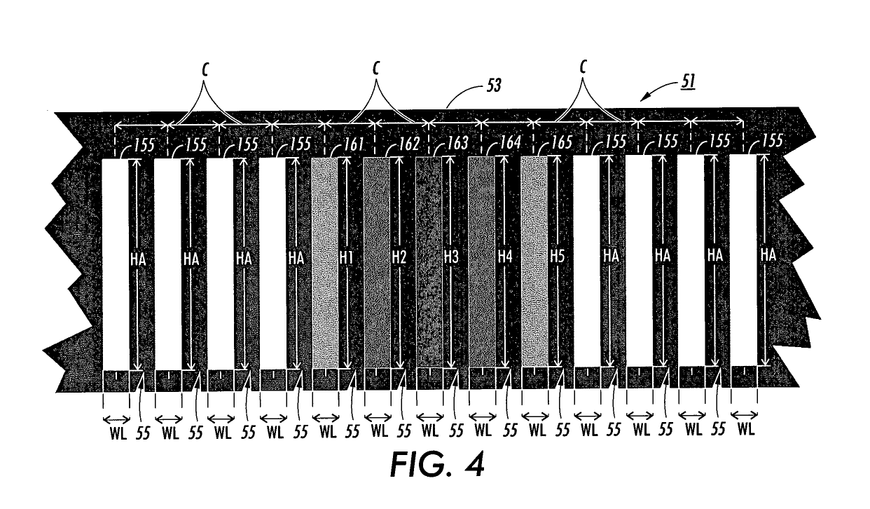

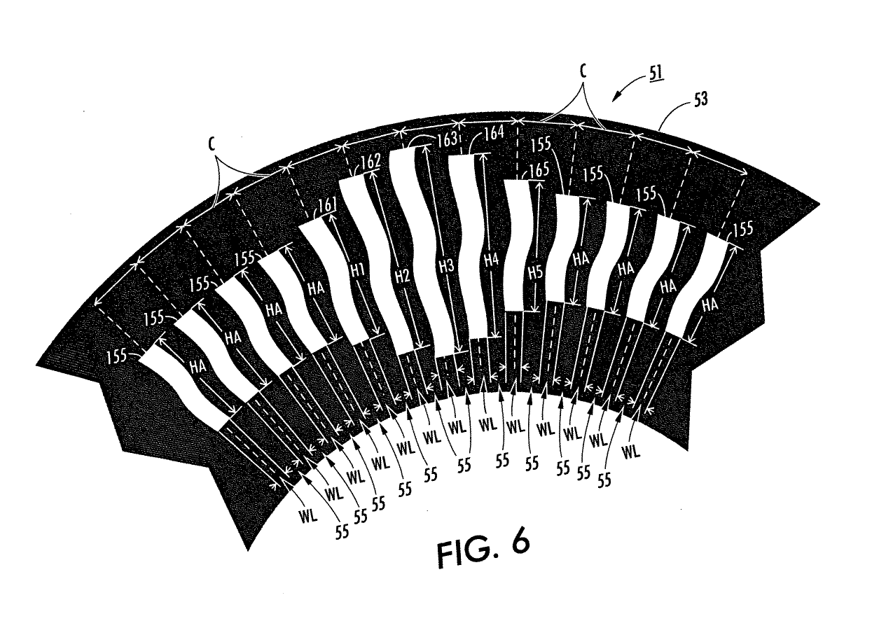

FIGS. 3 and 4 schematically illustrate embodiments of an optical encoder grating that includes a linear optical track 51 disposed on a linearly translatable strip 53. The optical track includes alternating dark areas 55 and light areas 155, 161, 162, 163, 164, 165 arranged in a line. The light areas 155, 161-165 can be generally rectangular, each having substantially the same width WL and a height HA, H1-H5, and can be substantially uniformly linearly spaced center to center C so as to have a constant pitch. The dark areas 55 between the light areas can have a substantially constant width and can be as tall as the tallest of the light areas 155, 161-165. The light areas 161-165 are contiguously adjacent, and the light areas 155 can be on one or both sides of the light areas 161-165. The side edges of the light areas 155, 161-165 can be linear, or they can be non-linear as schematically illustrated in FIG. 6 for a circular optical track. In this manner, the sides of the dark areas 55 can be linear or non-linear.

Each of the light areas 155, 161-165 can be uniform, shaded or patterned, for example. Suitable patterns can include line segments, dots, or rectangles.

The contiguously adjacent light areas 161-165 are more particularly optically different from the light areas 155 which can be optically substantially identical, such that the quadrature output waveforms of the quadrature sensor 119 change in amplitude when the light areas 161-165 are sensed by the quadrature sensor 119. In other words, the light areas 161-165 are configured to modulate the light sensed by the quadrature sensor 119 (FIG. 2) so that the quadrature waveforms change in amplitude. Such change can be detected to indicate a particular linear position of the optical grating 117 (FIG. 2) and thus a particular linear position of the printhead 31 (FIG. 2), for example. Alternatively, a single optically different light area can be employed instead of a plurality of contiguously adjacent optically different light areas 161-165, for example wherein the light area 163 is the sole light area that is optically different from the light areas 155,161-162 and 164-165.

For example, as schematically depicted in FIG. 3, the contiguously adjacent light areas 161-165 can be shorter than the light areas 155, wherein the heights of the light areas 161-165 are less than the height of the field of view of the quadrature optical encoder sensor 119. That is, the heights of the light areas 155, 161-165 are configured such that the quadrature optical encoder can see the differences in height. As yet another example, the heights of the contiguously adjacent light areas 161-165 can be greater than the heights of the light areas 155 which can be of substantially identical height.

As yet another example, as schematically depicted in FIG. 4, the contiguously adjacent light areas 61-65 can be of darker than the light areas 155 which can be of substantially the same lightness, such that the light areas 161-165 have less reflectance in a reflective system or less transmissivity in a transmissive system. Alternatively, the light areas 161-165 can be lighter than the light areas 155 so as to have greater reflectance in a reflective system or greater transmissivity in a transmissive system. The different lightness and darkness can be achieved by different shades of gray, for example. Also, the light areas 161-165 can have a different pattern or patterns than the light areas 55, such that the light areas 161-165 can have less reflectance (in a reflective system) or transmissivity (in a transmissive system) than the light areas 155, or greater reflectance (in a reflective system) or transmissivity (in a transmissive system) than the light areas 155. In these implementations, the radial heights HA, H1-H5 can be substantially the same.

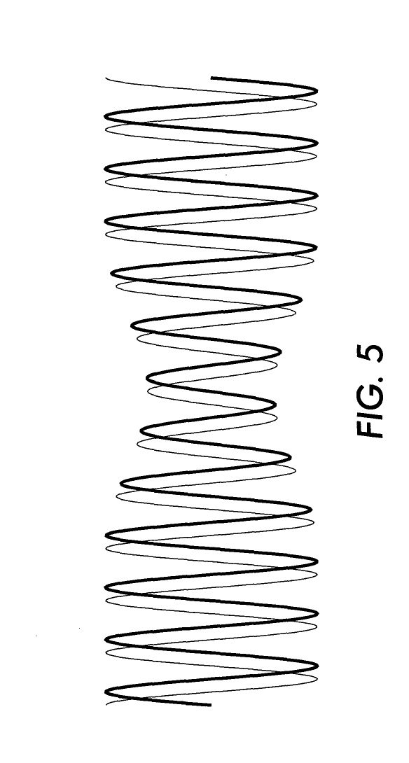

FIG. 5 sets forth schematic quadrature waveforms that would be produced as the optical track of FIG. 3 or FIG. 4 moves between the emitter and the detectors of the quadrature optical encoder sensor 119, for the example of darker light areas 161-165 and the example of shorter dark areas 161-165. For an implementation of lighter dark areas 161-165 or longer dark areas 161-165, the resulting waveforms would have a rise in amplitude.

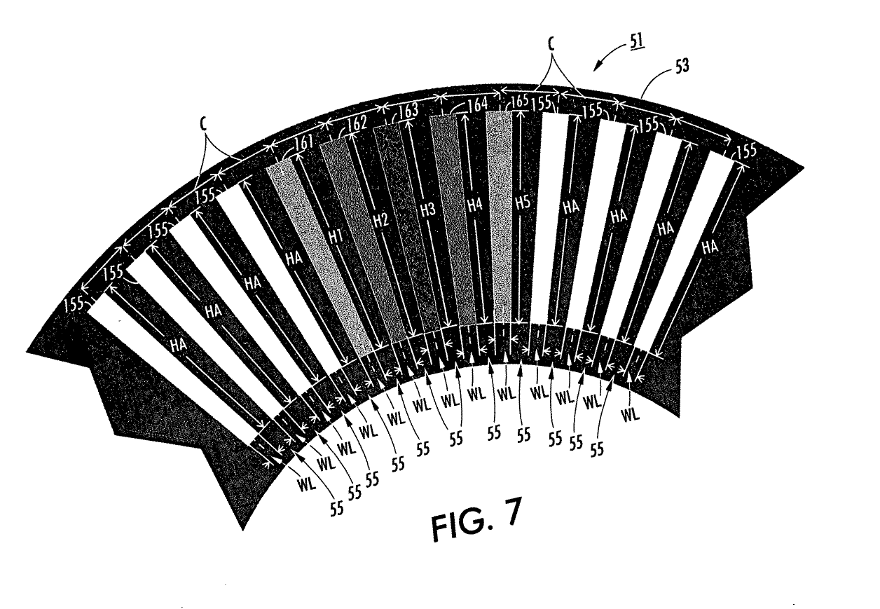

The foregoing concepts regarding the optical characteristics of encoder bars can be implemented in an encoder wheel or disc, for example as schematically illustrated in FIGS. 6 and 7. An encoder wheel or disc can be employed for example to detect the position of a rotatable print drum 11 (FIG. 1).

FIGS. 6 and 7 are schematic illustrations of embodiments of an optical encoder grating that includes a circular optical track 51 disposed on a rotatable disc 53. The optical track 51 includes alternating dark areas or bars 55 and light areas 155, 161, 162, 163, 164, 165 disposed in an arc about the center of the optical track 51. The light areas 155, 161-165 can be generally wedge shaped, comprising for example truncated circular sections or wedges. The light areas 155, 161-165 can have substantially the same angular width WL, and radial heights H1-H5 which can be different. The dark areas 55 of the track can have substantially the same angular width W and can be as tall as the tallest of the light areas 155, 161-165. The light areas 155, 161-165 can be uniformly angularly spaced center to center C so as to have a substantially constant pitch. The light areas 161-165 are contiguously adjacent, and light areas 155 can be on one or both sides of the contiguously adjacent areas 161-165. The sides of the light areas 155, 161-165 can be linear or they can be non-linear as schematically represented in FIG. 6. In this manner, the sides of the dark areas 55 can be linear or non-linear.

Each of the light areas 155, 161-165 can be uniform, shaded or patterned, for example. Suitable patterns can include line segments, dots, or rectangles.

The contiguously adjacent light areas 161-165 are more particularly optically different from the light areas 155 which are optically substantially identical, such that the quadrature output waveforms of the quadrature optical encoder sensor 19 (FIG. 1) change in amplitude when the dark areas 61-65 are sensed by the quadrature optical encoder sensor 19. In other words, the light areas 161-165 are configured to modulate the light sensed by the quadrature optical encoder sensor 19 so that the quadrature waveforms change in amplitude. Such change can be detected to indicate a particular angular position of the optical grating 17 (FIG. 1) and thus a particular angular position of the print drum 11 (FIG. 1), for example. Alternatively, a single optically different dark area can be employed instead of a plurality of contiguously adjacent optically different dark areas 61-65.

For example, as schematically depicted in FIG. 6, the light areas 161-165 can be shorter than the light areas 55, wherein the radial heights of the light areas 161-165 are less than the radial height of the field of view of the quadrature optical encoder sensor 119. That is, the radial heights of the light areas 155, 161-165 are configured such that the quadrature optical encoder can see the differences in radial height. As yet another example, the radial heights of the light areas 161-165 can be greater than the radial heights of the light areas 155 which can be of substantially identical radial height.

As yet another example, as schematically depicted in FIG. 7, each of the contiguously adjacent light areas 161-165 can be darker than the light areas 155 which can be of substantially the lightness, such that the light areas 161-165 have less reflectance (in a reflective system) or transmissivity (in a transmissive system). Alternatively, each of the light areas 161-165 can be lighter than the light areas 155 so as to have greater reflectance (in a reflective system) or transmissivity (in a transmissive system). The different lightness or darkness can be achieved by different shades of gray, for example. Also, the light areas 161-165 can have a different pattern or patterns than light areas 155, such that the light areas 161-165 can have a greater reflectance (in a reflective system) or transmissivity (in a transmissive system) than the light areas 155, or less reflectance (in a reflective system) or transmissivity (in a transmissive system) than the light areas 55.

Effectively, the optical characteristics of each of the light areas 161-165, 155 is configured to achieve a desired change in amplitude of the quadrature output waveforms of the quadrature optical encoder sensor 19 when the light areas 161-165 are sensed. It should be appreciated that the various techniques for changing the optical characteristics of the light areas can be employed individually or in combination.

Relative to the foregoing linear and circular optical tracks, the change in optical characteristics of the light areas 161-165 can be abrupt or gradual over the span of the light areas 161-165. For example, the heights of the contiguously adjacent light areas 161-165 can be substantially identical. As another example, the heights of the light areas 161-165 can decrease and then increase, whereby the light area 163 is the shortest. Similarly, the heights of the light areas 161-165 can increase and then decrease such that the light area 163 is the tallest of the light areas 161-165.

The invention has been described with reference to disclosed embodiments, and it will be appreciated that variations and modifications can be affected within the spirit and scope of the invention.

What is claimed is:

1. An optical encoder comprising:
an optical grating including alternating light areas and dark areas for modulating a beam of light;
a sensor for sensing modulated light provided by the optical grating;
the optical grating and the sensor being movable relative to each other;
wherein the optical grating includes a first plurality of contiguously adjacent light areas and a plurality of second light areas, wherein the contiguously adjacent first light areas and the second light areas are substantially uniformly spaced and wherein the contiguously adjacent first light areas are optically configured to change an amplitude of an output of the sensor.

2. The optical encoder of claim 1 wherein the dark areas are of substantially identical width.

3. The optical encoder of claim 1 wherein the contiguously adjacent first light areas are shorter than the second light areas.

4. The optical encoder of claim 1 wherein the contiguously adjacent first light areas are shorter than the second light areas and are of gradually changing height.

5. The optical encoder of claim 1 wherein the continguously adjacent first light areas are taller than the second light areas.

6. The optical encoder of claim 1 wherein the contiguously adjacent first light areas are taller than the second light areas and are of gradually changing height.

7. The optical encoder of claim 1 wherein the second light areas are of substantially identical lightness.

8. The optical encoder of claim 1 wherein the contiguously adjacent first light areas are darker than the second light areas.

9. The optical encoder of claim 1 wherein the contiguously adjacent first light areas are lighter than the second light areas.

10. The optical encoder of claim 1 wherein the contiguously adjacent first light areas are less transmissive than the second light areas.

11. The optical encoder of claim 1 wherein the contiguously adjacent first light areas are more transmissive than the second light areas.

12. The optical encoder of claim 1 wherein the light areas include non-linear sides.

13. The optical encoder of claim 1 wherein the plurality of second light areas are disposed on both sides of the contiguously adjacent first light areas.

14. An optical encoder comprising:
an optical grating including alternating light areas and dark areas for modulating a beam of light, wherein the dark areas include non-linear sides;
a sensor for sensing modulated light provided by the optical grating;
the optical grating and the sensor being movable relative to each other; and
wherein the optical grating includes a first plurality of contiguously adjacent light areas and a plurality of second light areas, wherein the contiguously adjacent first light areas and the second light areas are substantially uniformly spaced and wherein the contiguously adjacent first light areas are transmissively different from the second light areas.

15. The optical encoder of claim 14 wherein the dark areas are of substantially identical width.

16. The optical encoder of claim 14 wherein the second light areas are of substantially identical lightness.

17. The optical encoder of claim 14 wherein the contiguously adjacent first light areas are darker than the second light areas.

18. The optical encoder of claim 14 wherein the contiguously adjacent first light areas are lighter than the second light areas.

19. The optical encoder of claim 14 wherein the contiguously adjacent first light areas are less transmissive than the second light areas.

20. The optical encoder of claim 14 wherein the contiguously adjacent first light areas are more transmissive than the second light areas.

21. A position encoder comprising:
an optical track for providing a pattern of alternating light and dark areas, wherein the light areas are substantially uniformly spaced and optically encoded to define a predetermined position; and
a quadrature sensor for detecting the pattern of alternating light and dark areas.

22. A position encoder comprising:
means for providing a pattern of alternating light and dark areas; and
means for detecting movement of the pattern to determine a position of the pattern.

23. An optical grating comprising:
alternating light areas and dark areas for modulating a beam of light; and
wherein the light areas comprise a first plurality of contiguously adjacent light areas and a plurality of second light areas, wherein the contiguously adjacent first light areas and the second light areas are substantially uniformly spaced and wherein the contiguously adjacent first light areas are optically different from the second light areas.

24. The optical grating of claim 23 wherein the dark areas are of substantially identical width.

25. The optical grating of claim 23 wherein the contiguously adjacent first light areas are shorter than the second light areas.

26. The optical grating of claim 23 wherein the contiguously adjacent first light areas are shorter than the second light areas and are of gradually changing height.

27. The optical grating of claim 23 wherein the continguously adjacent first light areas are taller than the second light areas.

28. The optical grating of claim 23 wherein the contiguously adjacent first light areas are taller than the second light areas and are of gradually changing height.

29. The optical grating of claim 23 wherein the second light areas are of substantially identical lightness.

30. The optical grating of claim 23 wherein the contiguously adjacent first light areas are darker than the second light areas.

31. The optical grating of claim 23 wherein the contiguously adjacent first light areas are lighter than the second light areas.

32. The optical grating of claim 23 wherein the contiguously adjacent first light areas are less transmissive than the second light areas.

33. The optical grating of claim 23 wherein the contiguously adjacent first light areas are more transmissive than the second light areas.

34. The optical grating of claim 23 wherein the contiguously adjacent first light areas are optically different from the second light areas.

35. The optical grating of claim 23 wherein the light areas include non-linear sides.

36. The optical grating of claim 23 wherein the plurality of second light areas are disposed on both sides of the contiguously adjacent first light areas.

37. An optical grating comprising:
alternating light areas and dark areas for modulating a beam of light, wherein the dark areas include non-linear sides; and
wherein the light areas comprise a first plurality of contiguously adjacent light areas and a plurality of second light areas, wherein the contiguously adjacent first light areas and the second light areas are substantially uniformly spaced and wherein the contiguously adjacent first light areas are transmissively different from the second light areas.

38. The optical encoder of claim 37 wherein the dark areas are of substantially identical width.

39. The optical encoder of claim 37 wherein the second light areas are of substantially identical lightness.

40. The optical encoder of claim 37 wherein the contiguously adjacent first light areas are darker than the second light areas.

41. The optical encoder of claim 37 wherein the contiguously adjacent first light areas are lighter than the second light areas.

42. The optical encoder of claim 37 wherein the contiguously adjacent first light areas are less transmissive than the second light areas.

43. The optical encoder of claim 37 wherein the contiguously adjacent first light areas are more transmissive than the second light areas.

44. An optical grating comprising:
alternating light areas and dark areas for modulating a beam of light; and
wherein the light areas comprise a first light area and a plurality of second light areas, wherein the first light area and the second light areas are substantially uniformly spaced and wherein the first light area is optically different from the second light areas.

45. The optical grating of claim 44 wherein the dark areas are of substantially identical width.

46. The optical grating of claim 44 wherein the first light area is shorter than the second light areas.

47. The optical grating of claim 44 wherein the first light area is taller than the second light areas.

48. The optical grating of claim 44 wherein the second light areas are of substantially identical lightness.

49. The optical grating of claim 44 wherein the first light area is darker than the second light areas.

50. The optical grating of claim 44 wherein the first light area is lighter than the second light areas.

51. The optical grating of claim 44 wherein the first light area is less transmissive than the second light areas.

52. The optical grating of claim 44 wherein the first light area is more transmissive than the second light areas.

53. The optical grating of claim 44 wherein the light areas include non-linear sides.

54. The optical grating of claim 44 wherein the plurality of second light areas are disposed on both sides of the contiguously adjacent first light areas.
